(19) United States
(12) Patent Application Publication
(10) Pub. No.: US 2001/0045149 A1
(43) Pub. Date: Nov. 29, 2001

(54) Device for controlling ejection of cutting blade of a drum in a wipe material dispensing machine

(76) Inventor: Maurice Granger, Saint Priest En Jarez (FR)

Correspondence Address: HESLIN ROTHENBERG FARLEY & MESITI PC, 5 COLUMBIA CIRCLE, ALBANY, NY, 12203, US

(21) Appl. No.: 09/894,504

(22) Filed: Jun. 28, 2001

Related U.S. Application Data
(63) Continuation of application No. PCT/FR99/30118, filed on Dec. 14, 1999.

(30) Foreign Application Priority Data
Dec. 31, 1998 (FR) FR 98.16775

(51) Int. Cl. B26D 1/62

(52) U.S. Cl. 83/335; 83/649; 83/937

(57) ABSTRACT

The machine comprises a housing (1) with a cover (3), arms (2) which support a reel holder of wipe material, a drum (5) rotatably mounted between end shields (9), an articulated cutting device (6) which protrudes from the drum in order to make a cut, the reel of wipe material pressing against the drum. The device comprises, on one of the end shields (9) and around a ring (9a) through which the locking shaft of the drum passes, a fixed shaped part (12) of one-piece construction together with the body of the end shield, said shape (12) being designed to constitute a guide path for a matching part (13) associated with the blade holder and allowing, when the drum rotates, ejection of the blade and cutting. Said fixed shape (12) and said matching part (13) have protruding shapes (12a-13a) capable of cooperating with each other during rotation of the drum, thereby increasing the amplitude of the movement of lever-shape part (13) when it swivels, thus making the device operate smoothly.

The invention relates to the technical field of machines for dispensing material wipes of the cellulose wadding or similar type for wiping the hands or toilet paper, with the strip of material being in folded or unfolded form.

The Applicant has developed numerous dispensing machines of this type which operate automatically or semi automatically.

The essential features of these machines are defined in the Applicant's French Patents FR-A-2.332.215, FR-A-2.340.887, especially as far as the device for controlling and actuating the cutting blade inside the drum and then ejecting it in order to cut the strip of paper which is pulled by the user.

The reader is briefly reminded that a machine of this type comprises a housing (1) capable of accommodating a hinged cover (3). The housing has arms (2) which support a reel holder (4) of wipe material in its upper part. In the lower part, a drum (5) is rotatably mounted between end shields (9) and is designed to accommodate the cutting device (6) which itself comprises a cutting blade (6a) associated with a swivelling blade holder (6b) inside the drum which emerges from the drum in order to make a cut. The drum can be designed so that one of its ends has a cam (7) associated with a start and return spring (8), one end (8a) of which is attached to a finger (7a) associated with the cam and the other end (8b) of which is associated with a fixed part of one of the housing's lateral end shields (9). A second return spring ensures that the blade holder is linked to a fixed point in the drum. In above-mentioned patents, a cam device comprising cam associated with the shaft of the drum and an idler roller associated with the shaft of the blade holder make it possible to eject the blade when the drum rotates. In an embodiment that is specific to Patent 2.340.887, there is provision for a cam groove formed on the fixed end shield of the drum which accommodates above-mentioned idler roller.

All these arrangements have been widely and successfully used by the Applicant.

Nevertheless, there is still a first problem insofar as strips of wipe material, especially those obtained by recycling, are of highly variable quality and thickness depending on the country which produced them. These strips of wipe material also vary in terms of their field of use and the application area of the material, e.g. hand wipes, toilet paper. The machine must therefore be capable of operating normally under all circumstances, regardless of the direction in which the strip is pulled by the user. In certain cases, the material is very fragile if it is produced by recycling.

There is another problem insofar as noise abatement standards apply in many communal areas, in hospitals for instance, and it is therefore necessary for the machine to operate very silently under all circumstances.

The machines developed by the Applicant which correspond to the above-mentioned patents only meet the requirements stated above to an inadequate extent.

The aim sought after according to the invention was to overcome these drawbacks by designing a new device which combines specific new shapes, making it possible to eliminate, or at least substantially reduce, noise during the cutting process, regardless of the nature of the material or the material of which the device is made.

According to a first aspect of the invention, the device is distinctive in that it comprises, on one of the end shields and around a ring through which the locking shaft of the drum passes, a fixed shaped part of one-piece construction together with the body of the end shield, said shape being designed to constitute a guide path for a matching part associated with the blade holder and allowing, when the drum rotates due to the tensile force exerted on the strip of material by the user, ejection of the blade and cutting,

and in that said fixed shape and said matching part have protruding shapes capable of cooperating with each other during rotation of the drum, thereby increasing the amplitude of the movement of the lever-shape part when it swivels, thus making the device operate smoothly.

These aspects and others will become apparent from the following description.

The object of the present invention is described, merely by way of example, in the accompanying drawings in which:

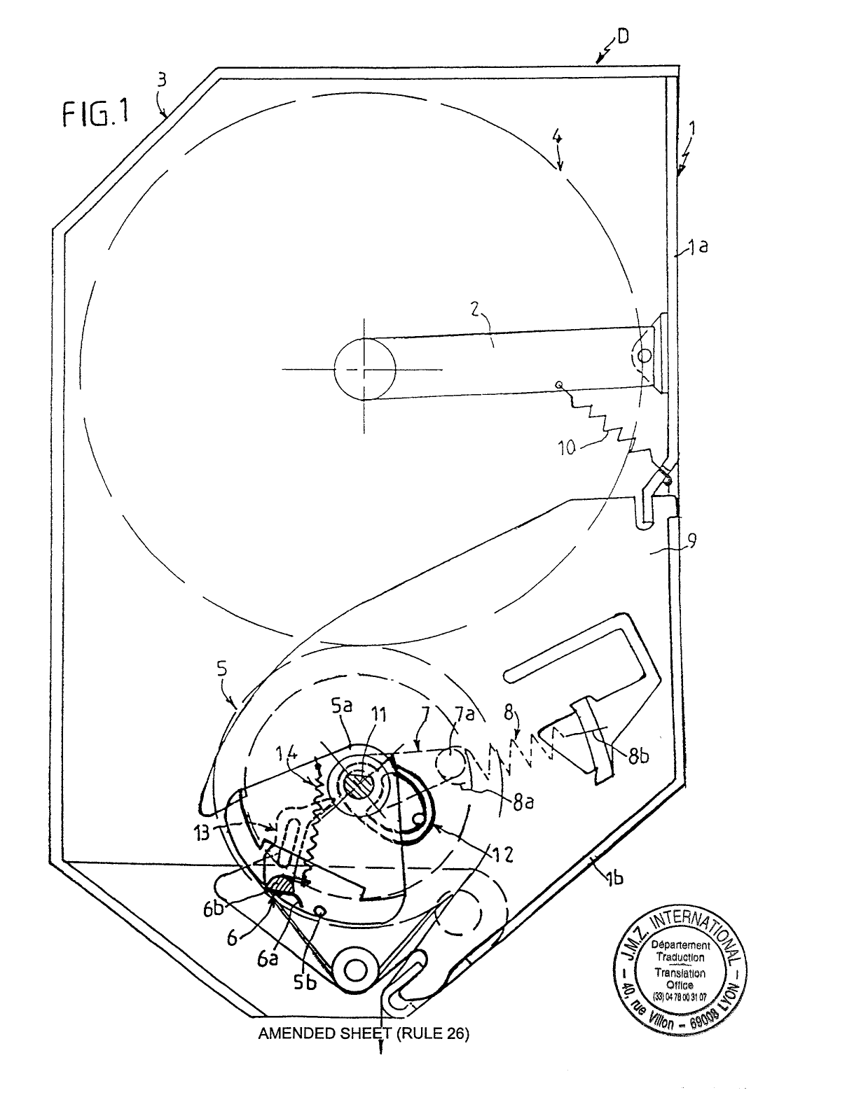

FIG. 1 is a cross sectional view of a wipe material dispensing machine that includes the device according to the invention shown in its idle position.

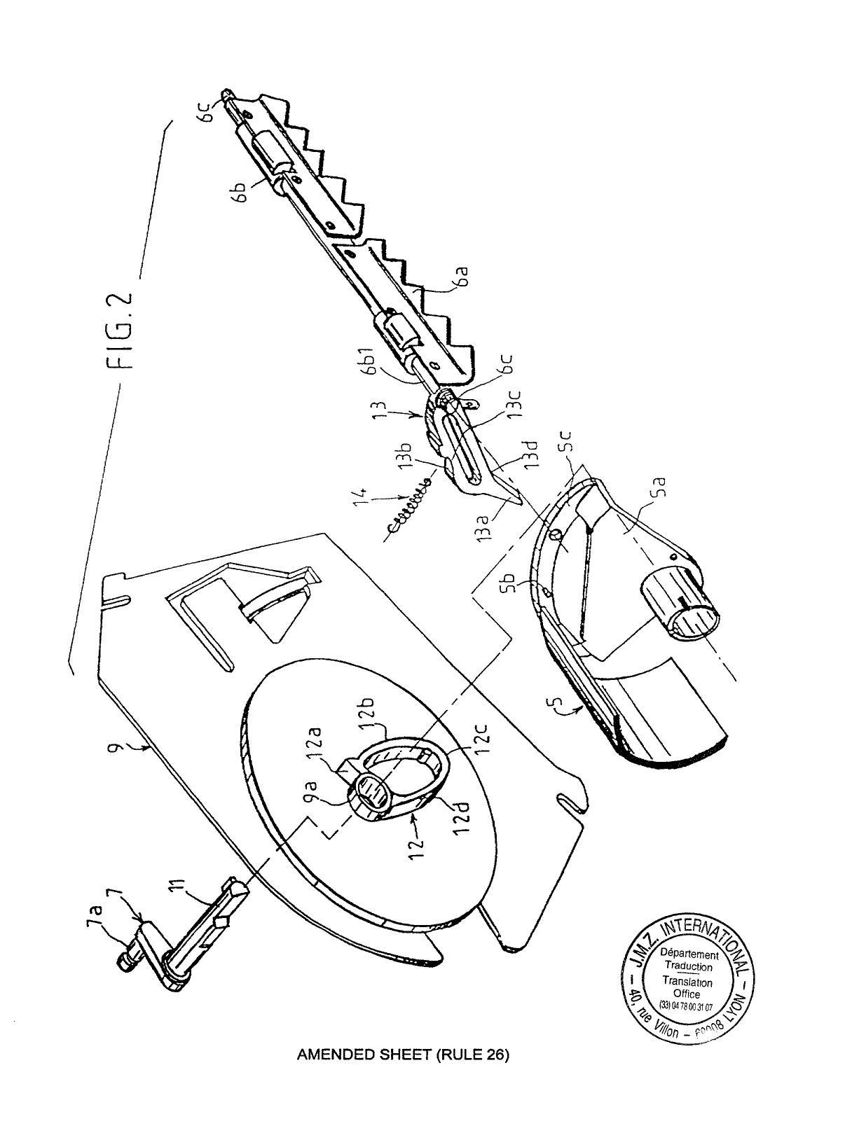

FIG. 2 is a partial exploded view illustrating the device before assembly with a special representation of the drum in order to show the aspects according to the invention.

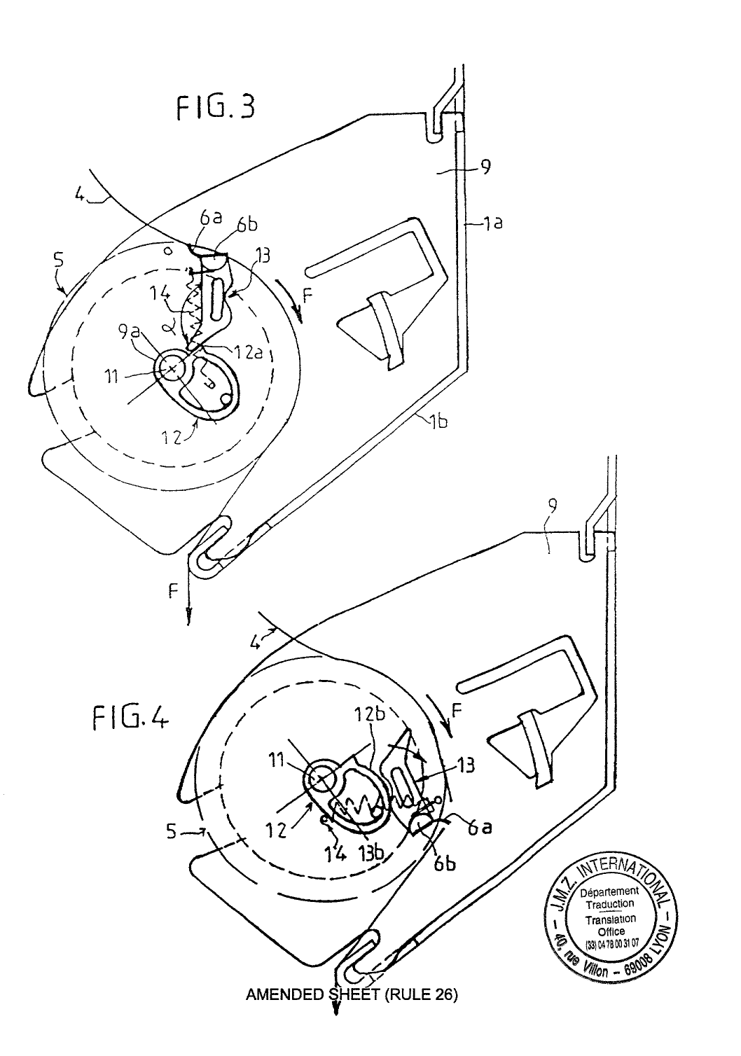

FIGS. 3, 4, 5 and 6 are partial sectional views showing the various phases of positioning the components that make up the device in the various operating phases of the machine.

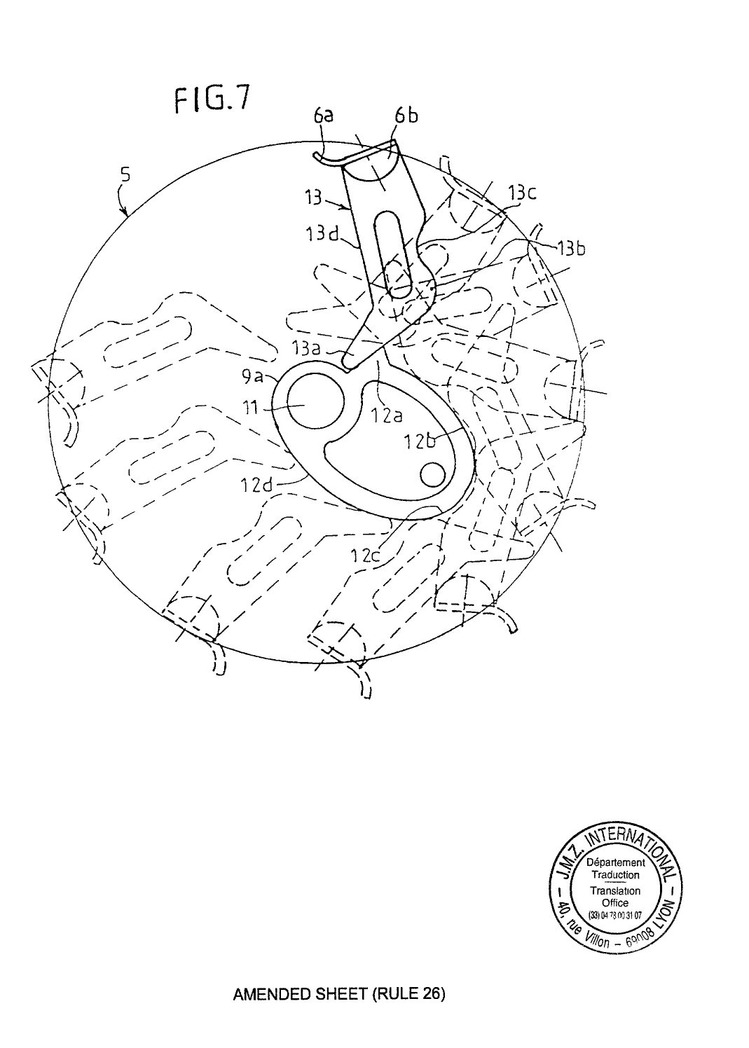

FIG. 7 is a partial view showing different successive positions of the components of the device as the drum rotates through one revolution.

In order that the present invention may be more readily understood, the following description is given, merely by way of example, reference being made to the accompanying drawings.

The dispensing machine (D) for material wipes is illustrated, showing only those parts that are essential in order to understand the invention. The machine comprises a housing (1) having a vertical back surface (1a), the lower part of which extends, for example, in a inclined plane (1b). Reel-holder arms (2) are installed on the back surface and used to accommodate the reel of wipes. One of the arms can be articulated by means of a spring (10) in order to load the reel. Lower end shields (9) are mounted by clicking them into the inclined plane of the housing or are fixed in any appropriate way. Between end shields (9), a drum (5) rotatably mounted on shafts (11) that connect to above-mentioned end shields is installed in a known manner. The drum is produced in any known way as described in the Applicant's two cited French Patents or other patents held by the Applicant. In particular, the drum accommodates, in a known manner, a cutting device (6) comprising a blade holder (6b) and blade (6a), said blade holder being articulated by shafts (6e) between above-mentioned end shields. A return spring (14) ensures elastic return of the blade holder. Also and in a known manner, the end of the drum's shaft has a cam (7) associated with a start spring attached to one of the end shields (9) of the housing.

The user is also reminded that the reel of wipes advantageously presses against the drum and the strip of material is routed so that it passes behind the drum and can be cut when the cutting device protrudes beyond the outer circumference of the drum. The strip of material emerges through the lower part of the machine. A protective cover ensures that the entire machine is enclosed.

The characteristics of the device according to the invention are explained below. The device for controlling and ejecting the drum's cutting blade comprises, on one of the end shields (9) and around a ring (9a) through which the locking shaft of the drum passes, a fixed shaped part (12) of one-piece construction together with the body of the end shield. Said shape (12) is devised to constitute a guide path for a matching part (13) associated with the blade holder and making it possible, when the drum rotates due to the tensile force exerted on the strip of material by the user, ejection of the blade and cutting. Said fixed shape (12) has, as a special feature, a protruding nose (12a) having a substantially triangular configuration and located opposite the ring (9a) through which the shaft of the drum passes. This protruding nose extends towards the rear of the end shield as a curved plane (12b) away from said ring describing a contour (12c) forming a curved apex of smaller radius before returning through a curved plane 12d) towards above-mentioned ring (9a) in an area opposite the point at which protruding nose (12a) is joined to ring (9a). This defines a guide path for part (13) associated with the blade holder.

Said part (13) is located and joined to one of the ends (6b1) of the blade holder. This part is perpendicular to the longitudinal axis of the blade holder and runs over a length opposite profiled shape (12) forming a cam path and is adjacent to one lateral end shield (5a) which is part of the drum. Said lever-shaped part (13) has a flattened shape with, at its end, a long protrusion (13a) forming a nose and is capable, in certain operating phases of the device, of being in contact with above-mentioned shape (12). Part (13) extends beyond protrusion (13a) as an upper area (13b) forming a bump which exerts a pressure force on shape 12) in certain operating phases. Said upper area extends with a slight dip (13c) located near the area where it is joined to the blade-holder shaft.

In order to limit swivelling of the blade holder, a stud (5b) is provided on the end shield (5c) of the drum.

The opposite surface (13d) of part (13) is straight and ends in said protruding end (13a) forming a nose. There is an angle (α) of the order of 130 to 160° between said straight surface and the nose. If applicable, said part (13) may have an internal cut-out in order to make it lighter.

The operating principle of the device is now explained, reference being made to FIGS. 3 to 7.

FIG. 3 shows the device according to the invention when a tensile force is first exerted on the strip of material. This corresponds to the position in which protruding part (13a) forming a nose of the blade holder is up against the protruding straight surface (12a) of the nose of the cam-shaped part (12). This limit stop position is before swivelling of the blade holder.

In FIG. 4, the operator has pulled the strip of material in the direction shown by arrow (F) causing movement of the drum. The blade holder is therefore swivelled and part (13) has escaped from the protruding part forming a nose (12a) and has come against curved area (12b), thereby following the cam path. This phase corresponds to cutting of the material by tearing.

In FIG. 5, rotation of the drum continues and the cut strip of material escapes towards the bottom of the machine. Lever-shaped part (13) follows the cam path by returning back to area 12d). The cutting blade is still in this position and protrudes beyond the drum.

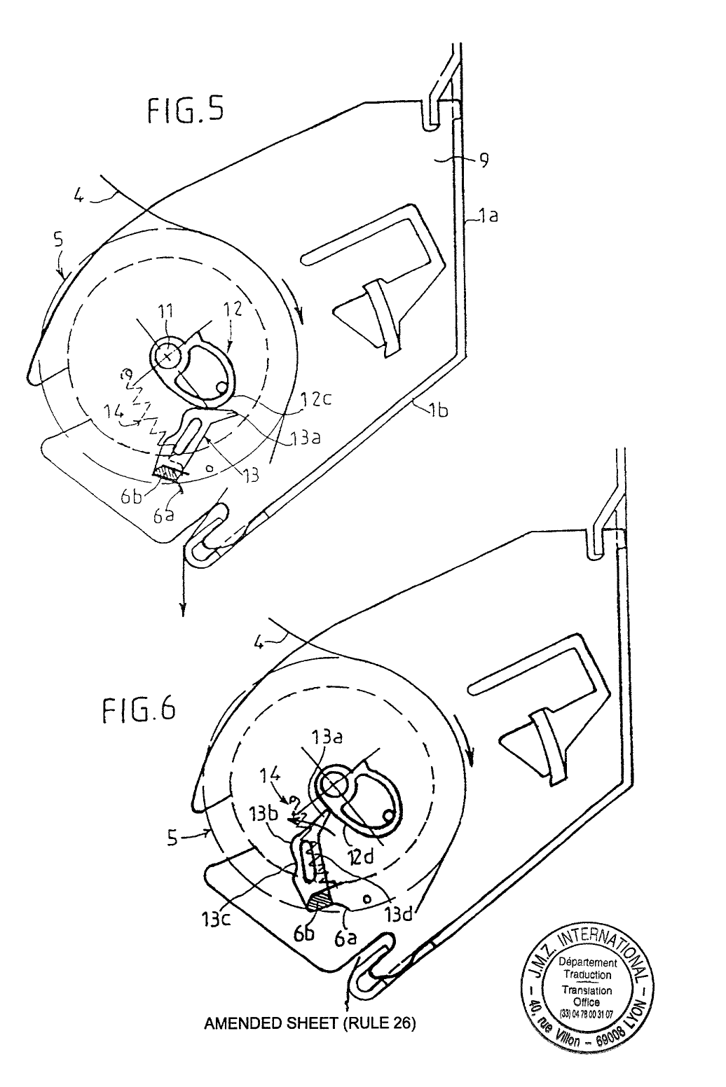

In FIG. 6 the device is in its end-of-travel position at the moment the blade holder swivels in the opposite direction, thus allowing the blade to be retracted inside the drum.

FIG. 7 schematically shows the various positions of part 13 that forms a lever relative to shaped part (12) forming a cam over one complete revolution of the drum.

The device according to the invention has the advantage, thanks to the specific configuration of parts 12 and 13 and their respective protruding noses, of increasing the amplitude of the movement of the lever as it swivels, therefore producing smooth operation not achieved by devices of prior art.

1. Device for controlling ejection of cutting blade of a drum in a wipe material dispensing machine, said machine comprising a housing (1) with a cover (3), said cover accommodating arms (2) which support a reel holder of wipe material in its upper part and, in its lower part, a drum (5) rotatably mounted between end shields (9), the drum being designed to accommodate a swivelling cutting device (6) which emerges from the drum in order to make a cut, the reel of wipe material pressing against the drum, said drum being designed with, at one end, a cam (7) associated with a start and return spring (8), the device being characterised in that it comprises, on one of the end shields (9) and around a ring (9a) through which the locking shaft of the drum passes, a fixed shaped part (12) of one-piece construction together with the body of the end shield, said shape (12) being designed to constitute a guide path for a matching part (13) associated with the blade holder and making it possible, when the drum rotates due to the tensile force exerted on the strip of material by the user, ejection of the blade and cutting,
and in that said fixed shape (12) and said matching part (13) have protruding shapes (12a-13a) capable of cooperating with each other during rotation of the drum, thereby increasing the amplitude of the movement of lever-shape part (13) when it swivels, thus making the device operate smoothly.

2. Device as claimed in claim 1 characterised in that the protruding shape (12a) forming a nose has a substantially triangular configuration and is located opposite the ring (9a) through which the shaft of the drum passes, said protruding nose extending towards the rear of the end shield as a curved plane (12b) away from aid ring and describing a contour (12c) forming a curved apex of smaller radius before returning through a curved plane 12d) towards above-mentioned ring (9a) in an area opposite the point at which protruding nose (12a) is joined to ring (9a), thereby defining a guide path for part (13) associated with the blade holder.

3. Device as claimed in either claim 1 or 2 characterised in that said part (13) is located and joined to one of the ends (6b1) of the blade holder and is perpendicular to the longitudinal axis of the blade holder, said part running over a length opposite profiled shape (12) forming a cam path and being adjacent to one lateral end shield (5a) which is part of the drum.

4. Device as claimed in any of claims 1 to 3 characterised in that said lever-shape part (13) has a flattened shape with, at its end, a long protrusion (13a) forming a nose and is capable, in certain operating phases of the device, of being in contact with above-mentioned shape (12), said part (13) extending beyond protrusion (13a) as an upper area (13b) forming a bump which exerts a pressure force on shape (12) in certain operating phases, said upper area extending with a slight dip (13c) located near the area where it is joined to the blade holder shaft.

5. Device as claimed in claim 4 characterised in that the opposite surface (13d) of part (13) is straight and ends in said protruding end (13a) forming a nose and in that there is an angle (α) of the order of 130 to 160° between said straight surface and the nose.

6. Device as claimed in claim 4 characterised in that said part (13) may have an internal cut-out in order to make it lighter.

7. Device as claimed in claim 4, in order to limit swivelling of the blade holder, a stud (5b) is provided on the extreme end shield (5c) of the drum.
